(19) United States
(12) Patent Application Publication
(10) Pub. No.: US 2011/0268548 A1
(43) Pub. Date: Nov. 3, 2011

(54) Robot gripper and manipulating robot

(76) Inventor: Fredy Doll, Achern (DE)

(21) Appl. No.: 13/066,920

(22) Filed: Apr. 27, 2011

(30) Foreign Application Priority Data
Apr. 28, 2010 (DE) 10 2010 018 963.4

(51) Int. Cl. B66F 9/00; B25J 15/00

(52) U.S. Cl. 414/688; 294/213; 414/815

(57) ABSTRACT

A robot gripper for grasping, transporting, and depositing goods in transit including a gripper base having a coupling device for attachment to a robot arm, a carrying device extending in the longitudinal direction of the gripper and having a carrying surface which carries the object in transit and extends substantially in the longitudinal and transverse directions of the gripper, and a displacement device disposed above the carrying device and serving to apply force to the object in transit in the longitudinal direction. The carrying device and the displacement device are capable of being moved relative to each other in the longitudinal direction. A holding device is provided on the displacement device, by means of which holding device a holding force can be generated in order to prevent an object in transit resting against the holding device from losing contact therewith.

### FIELD OF APPLICATION AND PRIOR ART

This application claims the priority of the German patent application No. 10 2010 018 963.4. The whole disclosure of this prior application is herewith incorporated by reference into this application.

The invention relates to a robot gripper for grasping, transporting, and depositing goods in transit, more particularly pieces of baggage such as suitcases and traveling bags. Such a generic robot gripper comprises a gripper base on which there is mounted a coupling device for attachment to a robot arm. Furthermore, the generic robot gripper comprises a carrying device that extends in a longitudinal direction of the gripper and comprises a carrying surface that serves to support the goods in transit and that extends substantially in the longitudinal and transverse directions of the gripper. Furthermore, there is provided a displacement device that is disposed above the carrying device in an upward vertical direction of the gripper and that serves to apply a force, in the longitudinal direction of the gripper, to the object in transit. The carrying device and the displacement device are capable of being moved relatively to each other in the longitudinal direction of the gripper.

The invention further relates to a robot comprising a robot gripper and to methods of loading and unloading goods in transit onto a robot gripper and off the same respectively.

A generic robot gripper is disclosed in DE 10 2005 022 828 A1. In this robot gripper, the carrying device is formed by box portions that can slide into each other telescopically. The displacement device is formed by a stop member such as a slide that can grasp, from the side, objects disposed on the carrying device.

The comparatively complex telescopic design comprising telescopic boxes disclosed in DE 10 2005 022 828 A1 solves the problem to the effect that the space on that side of the robot gripper that is remote from the object in transit is confined due to the presence of the robot arm at this location with consequent lack of accommodation for large gear elements. However, the design is very restricted in terms of the type of loading operation since it is possible only with difficulty to slide the object in transit onto the steps formed by the box portions so that the type of loading operation from a conveyor belt, as described in DE 10 2005 022 828 A1, can hardly be replaced. The pickup of goods in transit from a flat underlying surface by means of the gripper disclosed in DE 10 2005 022 828 A1 is either impossible or is at least problematic.

### OBJECT AND ITS ACHIEVEMENT

It is an object of the invention to develop a generic robot gripper such that it can be produced in a simple manner and, in particular, as a lightweight device that can very flexibly and reliably pick up and deposit goods in transit, more particularly pieces of baggage.

According to the invention, this object is achieved in that the displacement device is provided with a holding device, by means of which a holding force can be produced that prevents the object in transit and resting against the holding device from losing contact therewith.

Thus provision is made, according to the invention, for the displacement device disposed, at least during the transporting operation, at the rear, that is to say, in a position oriented toward the gripper base, to comprise a holding device, by means of which the displacement device can produce the aforementioned holding force when in holding contact with the object in transit. Thus this holding force prevents the object in transit from losing contact in the direction pointing away from the gripper base.

The following terms used in the context of this document should be understood to have the following meanings: the “upward vertical direction of the gripper” is defined by a normal to the carrying surface of the carrying device. The “longitudinal direction of the gripper” extends orthogonally to the upward vertical direction of the gripper in the direction in which the carrying device and the displacement device are capable of being moved relatively to each other. The “transverse direction of the gripper” extends orthogonally to the vertical and longitudinal directions of the gripper. The term “toward the front” denotes a direction starting from the gripper base and extending in the longitudinal direction of the gripper toward the distal end of the carrying device. The term “toward the rear” denotes the opposite direction. The terms “top” and “bottom” relate to the neutral position of the robot gripper in which the carrying device is oriented horizontally such that a piece of baggage can be carried thereby.

The configuration of the invention comprising a holding device allows the object in transit to be secured on the carrying device in addition to the holding effect caused by friction between the object in transit and the carrying device. The essential advantage is that the configuration of the displacement device comprising a holding device makes it possible to manipulate the goods in transit in a very advantageous manner, particularly before contact has been established between the object in transit and the carrying device, so that an ideal loading operation can be achieved. Likewise, the object in transit can be manipulated during the unloading operation after it has lost contact with the carrying device and can thus be dumped down gently, for example. This is explained hereinafter with reference to the methods of the invention and the exemplary embodiments of the invention.

The displacement device and the carrying device jointly delimit the receiving area for the objects to be carried by both devices, the displacement device delimiting the receiving area toward the rear in the longitudinal direction of the gripper and the carrying device delimiting the receiving area at the bottom of the robot gripper. Preferably, there are no portions of the gripper of the invention that extend into this receiving area above the displacement device so that goods in transit are not restricted as regards height.

The holding device is configured so as to produce the aforementioned holding force. In the simplest case, it can be configured to be passive and thus not switchable, for example, by the provision of Velcro surfaces or other adhesively acting surfaces on the displacement device. However, it is advantageous when the holding device is in the form of a switchable holding device. For this purpose, designs are possible, for example, in which the holding device comprises a switchable electromagnet for holding the goods in transit by means of a magnetic force, or has a holding surface that has a passive property per se, but can be displaced in a controlled manner in terms of its position relative to the carrying device in the upward vertical and transverse directions of the gripper, in order to deliberately cause the holding device to lose contact with the goods in transit.

However, a suction device that is configured to hold the goods in transit by means of a negative pressure is regarded as being particularly advantageous, since the functional efficiency of such a suction device depends only to a comparatively small extent on the shape of the goods in transit.

Motor-driven displacement of the holding device is not required in most embodiments, particularly when a suction device is used, so that the motor required for the movement of the displacement device relatively to the carrying device can be the only motor in the robot gripper.

In order to obtain a preferably flat holding contact between the goods in transit and the holding device irrespective of the actual orientation thereof in the plane of the vertical and longitudinal directions of the gripper, the holding device is mounted so as to be able to pivot preferably about a pivot axis of the holding device relatively to the gripper base or relatively to a main portion of the displacement device that is not pivotal relatively to the carrying device, the pivot axis of the holding device being preferably disposed at an unalterable distance from the carrying surface of the carrying device in the upward vertical direction of the gripper.

The pivot axis allows the holding device to be placed flat against the side face of the object in transit that is usually oriented vertically relative to the underlying surface even when the robot gripper itself is oriented in a preferred position for the operation of unloading or loading, in which it slopes downwardly toward the front. Preferably, no provision is made for a selectively controllable motor for the pivoting movement of the holding device relatively to the main portion or relatively to the gripper base. Instead, the holding device can come into contact with the object in transit solely by the movement of the robot gripper by means of a robot arm, and it can then be brought into flat contact with the object in transit by means of continued movement of the robot gripper.

In the case of a switchable holding device, it is regarded as being preferable when it comprises separately switchable holding elements such that it can be individually configured for each object in transit.

Particularly as regards lifting the goods in transit from the flat underlying surface, it is regarded as being very advantageous when the carrying device and the displacement device can be displaced relatively to each other in such a way that the holding device can be disposed in a first relative end position ahead of that distal end of the carrying device that is remote from the gripper base, as regarded in the longitudinal direction of the gripper. This first relative end position is thus distinguished by the fact that the distal end of the robot gripper that is remote from the robot base is formed by the holding device. The holding device can thus produce the intended holding force on the object in transit in this first relative end position in order to allow the object to be lifted from the flat underlying surface by means of this holding force to such an extent that the carrying device can then move into the gap thus formed.

Preferably, the displacement device and the carrying device are configured and capable of being moved relatively to each other in such a manner that the following situation can be achieved in the first relative end position: The robot gripper is inclined downwardly toward its distal end relative to a flat underlying surface, on which the goods in transit are located, the longitudinal direction of the gripper enclosing an angle with the plane of the flat underlying surface of less than 45°, preferably an angle of less than 30° or even an angle of less than 20°. The distal end of the carrying device rests against the flat underlying surface or is located just above the flat underlying surface. At the same time, the holding device rests against the object in transit at a height above the underlying surface that is the same as the height at which the holding device would rest against the object in transit if the latter were lying in a flat position on the carrying surface of the carrying device.

The position of the holding device above the carrying device defines the location at which the holding device is to bear against the object in transit so that the side face of the object in transit can be held by the holding device and the underside of the object in transit can lie flat on the carrying surface of the carrying device. The situation described above that can be achieved in this development of the robot gripper of the invention is aimed at enabling the holding device to rest in exactly this position against the object in transit and thus manifest the holding force even before any first displacement of the object to be picked up has taken place. As a result, the establishment of the holding force can be followed by a displacement of the robot gripper in its entirety, which alone enables an arrangement to be achieved in which the carrying device can move to underneath the object in transit, which is lifted at the side by means of the holding device. The smaller the angle mentioned above, the more acutely can the robot gripper approach the object in transit.

In a robot gripper of the invention, provision can be made for the carrying device to be capable of being moved in the longitudinal direction of the gripper relatively to the gripper base in order to create movability of the carrying device relatively to the displacement device, which in turn can be immovably mounted with respect to the gripper base. Likewise, it is alternatively possible to immovably mount the carrying device on the gripper base or to mount the carrying device such that it is only pivotal relatively to the gripper base about a carrying-device axis oriented in the transverse direction of the gripper and to configure the displacement device such that it is capable of being moved relatively to this carrying device.

An embodiment in which both the carrying device and the displacement device can be displaced in the longitudinal direction of the gripper relatively to the gripper base is of particular advantage. This makes it possible to achieve total movability of the carrying device relatively to the displacement device by implementing only half the displaceability of the carrying device and of the displacement device relatively to the gripper base. In such an embodiment, provision can be made for a forced coupling to be produced between the displacement device and the carrying device for achieving movement of the two devices in opposite directions, so that a single motor is sufficient for controlling the carrying device and the displacement device. However, an embodiment in which the displacement device and the carrying device are capable of being moved separately from each other relatively to the gripper base is advantageous, since this can lead to an increased flexibility in the operations of loading and unloading the goods in transit and in particular to an increase in the unrestricted range of movement of the robot arms in the manner described below.

In a second relative end position, which is contrary to the first relative end position and in which the displacement device is thus disposed close to the gripper base, and/or the carrying device is disposed remotely from the gripper base, the portion of the carrying device that can be used for the goods in transit and is disposed in front of the holding device preferably has a length of at least 15 cm in the longitudinal direction of the gripper. A length of at least 35 cm is more preferable and a length of at least 45 cm is even more preferable. These dimensions ensure secure transport of pieces of baggage commonly used by airline passengers.

Particularly as a development of the embodiment of a robot gripper described above, the invention further relates to a generic robot gripper which is characterized in that the carrying device is capable of being moved relatively to the gripper base in the longitudinal direction of the gripper, that the proximal end of the carrying device that is oriented toward the gripper base comprises two end portions that are spaced apart in the transverse direction of the gripper, leaving a free space therebetween, and the end portions of the carrying device are each disposed behind the coupling device, as regarded in the longitudinal direction of the gripper, and are opposite each other on each side of the coupling device in the transverse direction of the gripper in that end position of the carrying device that is oriented toward the gripper base.

The two end portions of the carrying device can preferably be two prongs of a forked carrying device. The two end portions can alternatively be subtransmissions such as toothed racks or worm spindles of a displacement device that serves to move the carrying device. A combination thereof is also possible. In an embodiment in which the end portions are formed by prongs of a carrying device, these prongs are preferably configured to be separate entities that are not rigidly interconnected. This enables the prongs to move relatively to the gripper base without the risk of collision. Advantageously however, the prongs are synchronized by means of a transmission, since the prongs are usually not required to be moved separately. In a special development of the invention, the prongs can be displaced toward each other manually or by means of a motor in the transverse direction of the gripper.

Following the same basic idea, the invention likewise relates to a generic robot gripper, preferably of the type described above, in which the displacement device can be displaced relatively to the gripper base and/or relatively to the carrying device in the longitudinal direction of the gripper, and the proximal end of the displacement device comprises two subtransmissions that are spaced apart in the transverse direction of the gripper and that leave a free space therebetween, and the subtransmissions are each disposed behind the coupling device, as regarded in the longitudinal direction of the gripper, and opposite to each other on each side of the coupling device, as regarded in the transverse direction of the gripper, in that end position of the displacement device that is oriented toward the gripper base.

The arrangement of the subtransmissions of the displacement device and the end portions of the carrying device on each side of the coupling device, as described above, provides a reliable mechanical solution for achieving movement of the carrying device and of the displacement device without this movement being hampered by the gripper base, or more particularly by the coupling device and the robot arm connected to the coupling device. Due to the displacement of the end portions and the subtransmissions past the coupling device on each side thereof, the displacement device and the carrying device can be displaced to a considerable extent, which is sufficient for most purposes. In order to produce particularly low-height robots with respect to the upward vertical direction of the gripper, it is regarded as being preferable when the end portions of the carrying device and the transmissions of the displacement device are disposed at the level of the coupling device in the upward vertical direction of the gripper.

Various embodiments have proved particularly advantageous for the displacement of the carrying device and/or the displacement device.

Thus provision is made, in a development of the invention, for the carrying device to be capable of being moved relatively to the gripper base in the longitudinal direction of the gripper, a drive belt being mounted at opposite ends of the carrying device, which drive belt is wrapped in the form of an Ω around two guide members immovably mounted in relation to the gripper base and around a driving wheel that is mounted for rotation about a drive axle that is incapable of being moved with respect to the gripper base. This Ω wrap of the drive belt represents a mechanically simple alternative for achieving movement of the carrying device relatively to the gripper base.

In another development of the invention, provision is made for the carrying device to comprise a main portion and a carrying element, preferably in the form of a conveyor belt that is guided on the main portion and that is capable of being moved relatively to the main portion and that forms the carrying surface of the carrying device. Thus, in such an embodiment, the carrying device is not provided in the form of a single element that is capable of being moved as a whole, but instead the carrying device comprises the aforementioned main portion and the aforementioned carrying element that are configured so as to be capable of being moved relatively to each other. Unless indicated otherwise, all references made in this document to the carrying device in embodiments comprising a separately movable main portion and a carrying element relate to the main portion. The separation of the carrying element forming the carrying surface from the main portion of the carrying device makes it possible to prevent relative movement between the carrying surface and the object in transit thereon during the movement of the object in transit on the carrying device so that damage to the object in transit is obviated. Advantageously, the carrying element is in the form of a conveyor belt that is guided around the distal end of the main portion at the distal end of the carrying device and that is preferably in the form of a continuous conveyor belt.

In this context, it is very preferable, in a first variant, when the carrying element is mounted so as to be incapable of movement, at least in part, in relation to the gripper base, while the main portion of the carrying device is configured to be capable of being moved relatively to the gripper base. In such a case, the conveyor belt serves as means for causing movement of the carrying device relatively to the gripper base, in that relative movement is achieved between the carrying device and the conveyor belt by means of a motor, which relative movement causes the desired movement of the carrying device in relation to the gripper base, since the conveyor belt is secured to the gripper base. Alternatively, it is possible, in a second variant, for the carrying element to be configured for movement in its entirety in relation to the gripper base, the displacement device being preferably permanently connected to a portion of the carrying element. In such an embodiment, the displacement of the carrying element in relation to the gripper base is sufficient to move the displacement device also. As a result, there is the added assurance that no relative movement can take place between the displacement device and the portion of the carrying element on which the object in transit lies.

As a further development of the invention, it has proved to be advantageous to provide a telescopic mechanism for the movement of the displacement device and/or the carrying device in relation to the gripper base, which telescopic mechanism comprises an intermediate member that can be moved relatively to the gripper base in the longitudinal direction of the gripper, and this movement of the intermediate member is operatively coupled to the movement of the displacement device and the carrying device in relation to the intermediate member in the longitudinal direction of the gripper. The telescopic mechanism, which can be in the form of a telescopic spindle, for example, allows the comparatively small displacement device or carrying device to be displaced over a very large distance.

The invention further relates to a manipulating robot particularly for grasping, transporting, and depositing goods in transit, such as pieces of baggage, which manipulating robot comprises a robot base that is stationary or that can be displaced on a rail system, and a robot arm which can move relatively to the robot base and at the end of which a coupling device is provided for coupling a robot gripper to the robot arm, and a robot gripper of the type described above is coupled to the coupling device of the robot arm.

Furthermore, the invention relates to methods of depositing and grasping goods in transit onto or from a substantially flat underlying surface by means of a robot gripper of the type described above.

As regards the method of grasping the goods in transit starting from an initial state in which the carrying device and the holding device are in a relative position in which the carrying device is disposed to the rear of the holding device, provision is made for the holding device to be moved to a side face of the object in transit located on said flat underlying surface with the carrying device disposed in a downwardly sloping position toward its distal end relative to the underlying surface. After the holding device has been advanced to a side face of the object in transit, the holding device is brought into holding contact with the side face thereof and then lifted, more particularly together with the entire robot gripper, so that the side face of the object in transit that is in contact with the holding device is lifted so as to tilt the object in transit. In this resulting tilted state of the object in transit, the carrying device is distended toward the front relatively to the holding device and thus moves to underneath the object in transit, and the object in transit is then lifted by means of the carrying device so as to leave the flat underlying surface.

Thus the method allows the object in transit that is located on the flat underlying surface and is not specifically designed for insertion of a carrying device to be grasped in that first one side of the object in transit is lifted. As a result, a state is achieved in which the carrying device can move to underneath the object. During the distension of the carrying device, that side of the object in transit that is located on the flat surface preferably remains stationary thereon so that this side of the object in transit is not subjected to damage caused by rubbing against the flat underlying surface. During its movement underneath the object in transit, the carrying device is thus preferably also moved relatively to the flat underlying surface.

It can be particularly advantageous when the direction of movement of the carrying device is oriented so as to diverge from the underside of the object in transit when the carrying device is moved forward under the object in transit, so that in a first phase of this movement, during which the carrying device is disposed underneath the object in transit, there is still no physical contact between the carrying device and the object in transit. Only when the carrying device has traveled through a certain distance, for example, 10 cm to 20 cm under the object in transit, will the carrying device be tilted so that it comes into flat contact with the object in transit. As a result, the underside of the object in transit is also free from the risk of damage caused by rubbing against the carrying device.

The depositing operation of the object in transit, as proposed by the invention, is carried out in reverse order by the robot gripper described above. Starting from an initial state, in which the object in transit lies on the carrying device and is in holding contact with the carrying device, the carrying device is positioned such that it slopes downwardly toward its distal end relative to an approximately flat underlying surface. One edge of the object in transit is then placed on the said flat surface by means of a relative displacement of the carrying device and the holding device. While maintaining the holding contact between the holding device and the object in transit, the carrying device is then retracted from underneath the said object preferably by first breaking the physical contact with the object by a tilting movement of the carrying device. After the carrying device has retracted from underneath the object in transit, the latter is lowered by means of the holding device until it rests completely on the flat underlying surface.

### BRIEF DESCRIPTION OF THE DRAWINGS

Additional aspects and advantages of the invention are revealed in the claims and the following description of preferred exemplary embodiments of the invention with reference to the drawings, in which:

FIGS. 1a to 1c show a first embodiment of a robot gripper of the invention in three positions of the respective displacement device relative to the respective carrying device,

FIG. 1d is a variant of the embodiment shown in FIGS. 1a to 1c,

FIGS. 2 to 7 show further embodiments of a robot gripper of the invention with various positions of the respective displacement device relative to the respective carrying device,

FIG. 8 and FIGS. 8a to 8e illustrate a loading operation carried out by means of the robot gripper shown in FIGS. 1a to 1c

FIG. 9 shows the geometric relationships when the holding device of the robot gripper shown in FIGS. 1a to 1c establishes a connection with the object 40 in transit,

FIG. 10 shows an alternative loading state as compared with that of the robot gripper shown in FIGS. 8a to 8e, and

FIGS. 11a, 11b, 12a, 12b show unloading operations in an embodiment of a robot gripper that is modified as compared with that shown in FIGS. 7a to 7c.

### DETAILED DESCRIPTION OF THE EXEMPLARY EMBODIMENTS

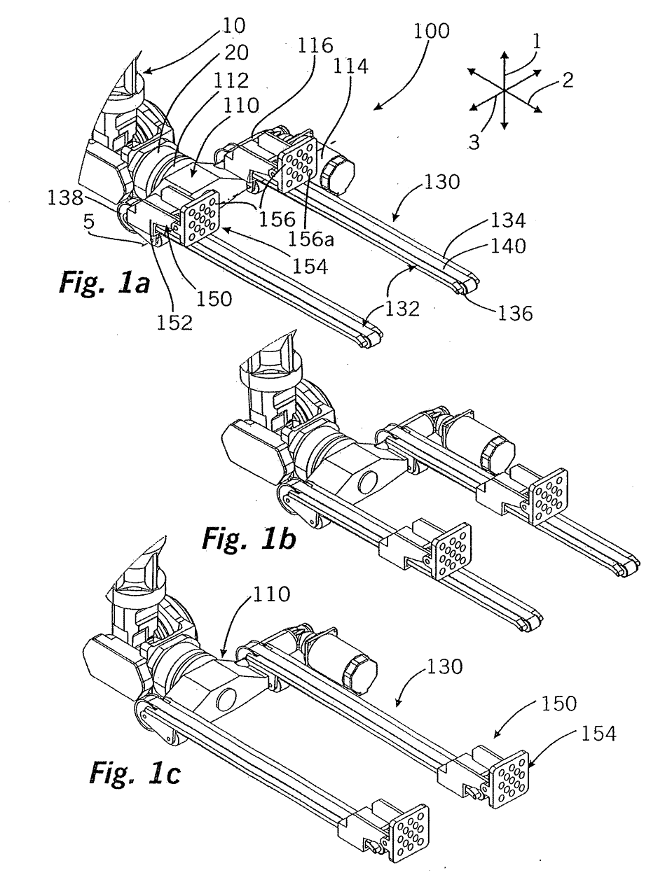

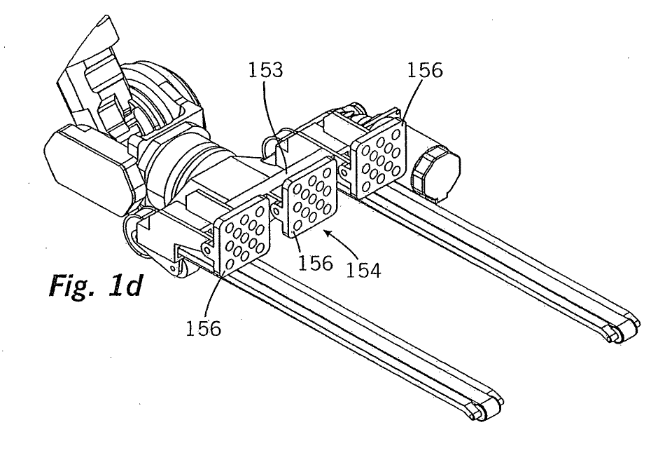

FIGS. 1a to 1c show a first embodiment of a robot gripper of the invention. This robot gripper 100 comprises a gripper base 110, on which there is provided a coupling device 112 in the form of a coupling flange for connecting the robot gripper to a coupling device 20 of a robot arm 10. The position and orientation of the gripper base 110 can thus be altered by a movement of the robot arm 10.

The robot gripper 100 further comprises a carrying device 130 comprising two carrying prongs 132 that extend from the gripper base 110 in the longitudinal direction 2 of the gripper. These carrying prongs 132 each comprise a base body 134 which is immovably attached to the gripper base 110 and at the distal ends of which deflection rollers 136 are provided. At the opposite, proximal end of the carrying prongs 132, there are provided driving rollers 138 that are driven synchronously via a transmission 116 by an electric motor 114 that is immovably mounted on the gripper base 110. A conveyor belt 140, which can be moved by the motor 114 in the longitudinal direction 2 of the gripper and the top portion of which forms a carrying surface for the object 40 in transit, extends around the driving rollers 138 and the deflection rollers 136 of each carrying prong.

A displacement device 150 is mounted for movement on the base bodies 134 of the carrying prongs 132, which displacement device 150 comprises a main part 152 for each carrying prong 132. The main parts 152 are guided for movement in relation to the associated base body 134 of the respective carrying prong 132. A holding device 154 comprising two holding members 156 is mounted for rotation about a horizontal pivot axis 5 relative to this main part 152. These holding members 156 of the holding device 154 are each configured to apply a holding force to the object in transit as it rests against the holding members, which holding force prevents displacement of the object 40 in transit. In this case, the holding device 154 is merely in the form of a suction holding device, for example. For this purpose, openings 156a, at which a vacuum can be generated by means of a suction device (not shown in the figures), are provided on the holding members 156. Such a suction holding device can likewise be provided in the other embodiments described below. Alternatively, other configurations such as electromagnetic holding devices are conceivable.

The displacement device 150, together with the holding device 154 articulated thereto so as to be pivotal about the axis 5, is capable of being moved in the longitudinal direction 2 of the gripper, as shown in FIGS. 1a to 1c, in which FIG. 1c shows a first relative end position and FIG. 1a shows a second relative end position. FIG. 1b shows an intermediate stage.

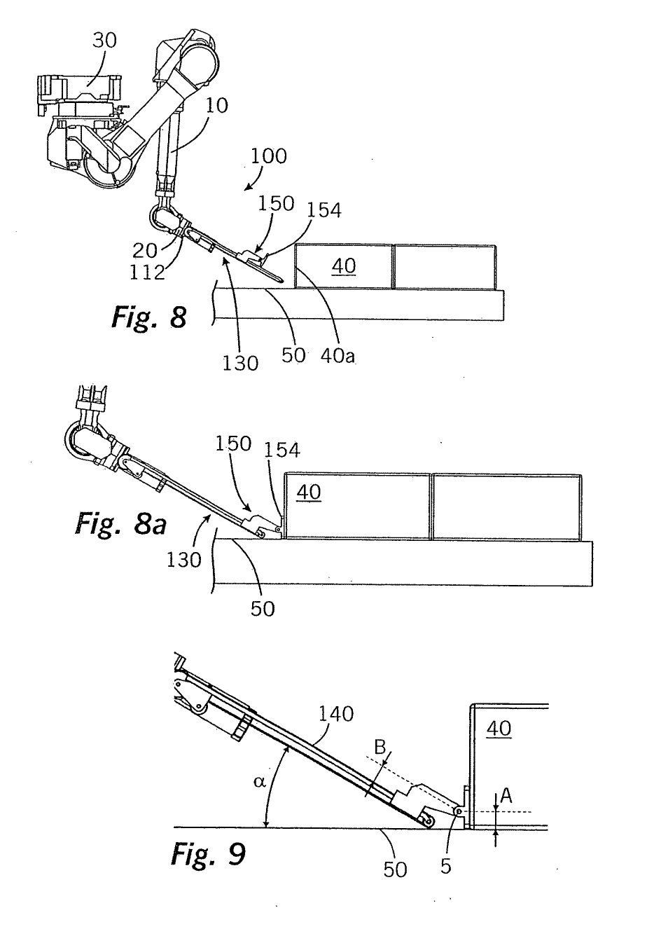

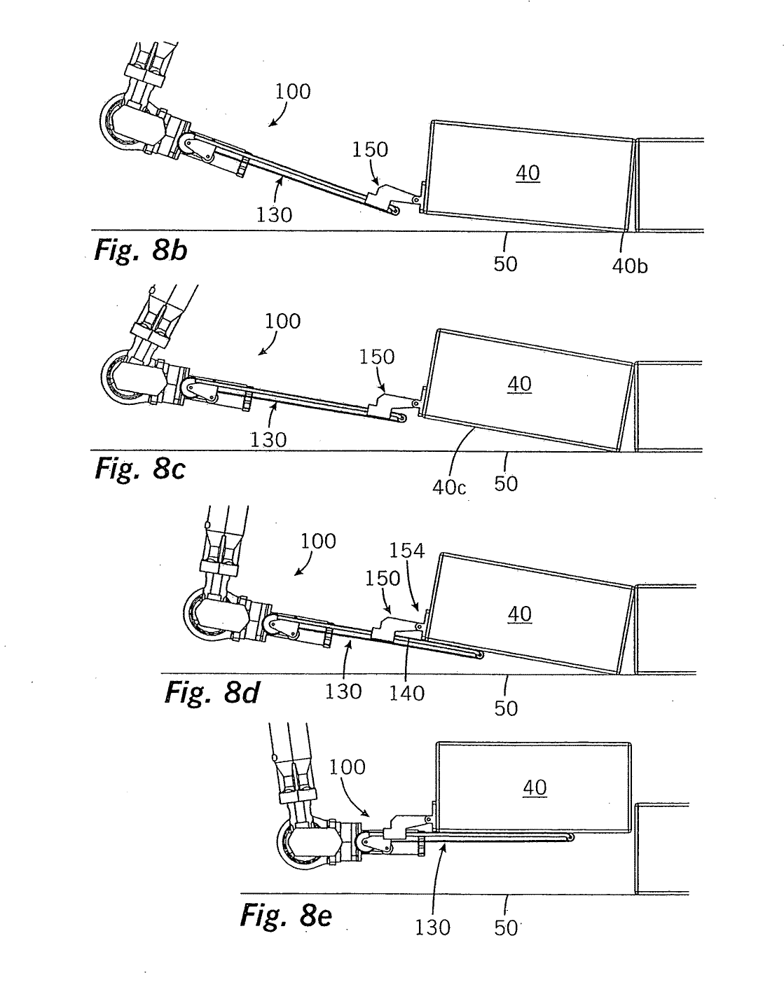

In the first relative end position shown in FIG. 1c, the holding members 156 of the holding device 154 protrude beyond the carrying device 130 and thus form the distal end of the robot gripper 100. The purpose of this large range of movement of the holding device is described below with reference to FIGS. 8 to 10.

FIG. 1d shows a slight modification of the embodiment shown in FIGS. 1a to 1c. In the embodiment shown in FIG. 1d, the two main parts 152 of the displacement device 150 are connected by a yoke 153 on which a third central holding member 156 is provided that has a similar construction as the outer holding members 156. As a result, a locally variable holding force can be applied to the holding members 156 in a more flexible manner.

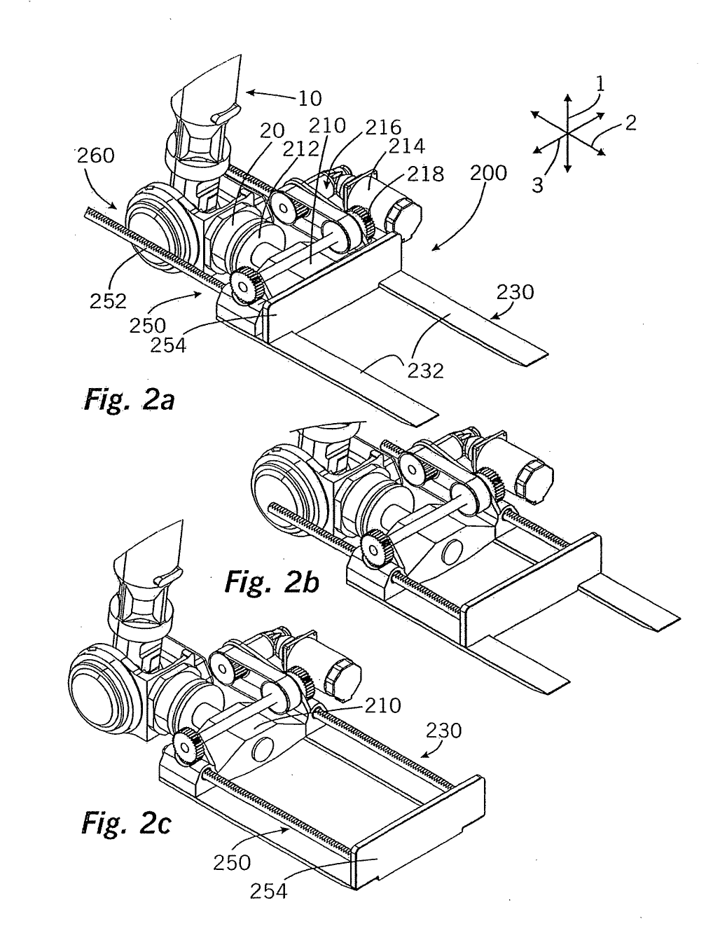

The embodiment shown in FIGS. 2a to 2c shows a robot gripper 200 that is similar to the embodiment shown in FIGS. 1a to 1c in terms of kinematics. Here again, a gripper base 210 is provided with a coupling device 212 for coupling the robot gripper to a robot arm 10. In this embodiment also, the carrying device 230 is permanently connected to the robot base 210. No conveyor belt is provided in this embodiment so that the two prongs 232 of the carrying device 230 are each mounted so as to be immovable in their entirety in relation to the gripper base 210. The displacement device 250 comprises two toothed racks 252, at the distal ends 252a of which the holding device 254 is provided. The holding device can be pivotally mounted as in the embodiment shown in FIGS. 1a to 1c or it can be immovable in relation to the toothed racks 252.

A motor 214 and a transmission 216 and two toothed wheels 218 enable displacement of the displacement device 250 to take place relatively to the gripper base 210 and the carrying device 230, as illustrated by the transition from the state shown in FIG. 2a to that shown in FIG. 2c. In the first relative end position shown in FIG. 2c, the holding device 254 is again disposed ahead of the distal ends of the prongs 232.

In the second relative end position shown in FIG. 2a, the toothed racks 252 extend beyond that end of the robot gripper 200 that is defined by the coupling device 212 and is oriented toward the robot arm and into the region of the robot arm 10. This embodiment comprising two toothed racks 252 that are spaced from each other to define an intermediate free space 260 provides a very reliable means for making movement of the displacement device 250 possible without this movement significantly restricting the movability of the robot arm 10.

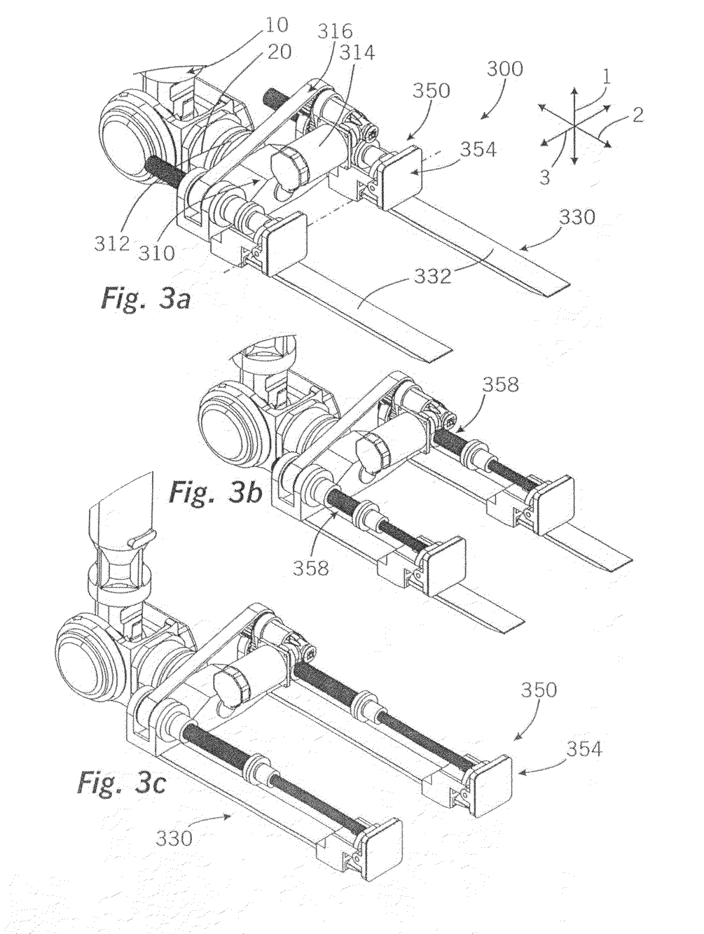

The robot gripper 300 shown in FIGS. 3a to 3c is identical to the embodiment shown in FIGS. 2a to 2c in terms of the movability of the carrying device 330 and the displacement device 350 relatively to the gripper base 320 provided with a coupling device 312. Here again, the carrying device 330 is formed by two carrying prongs 332, which are mounted so as to be immovable in relation to the gripper base 320 and which serve to guide the displacement device 350, which, by contrast, is capable of being moved in the longitudinal direction of the gripper. In a manner similar to that illustrated in FIGS. 1a to 1c, the two-piece displacement device 350 is provided with a holding device 354 that can pivot about a pivot axis 5 and comprises separate holding members 356 that jointly form a holding device 354.

The special feature of the embodiment shown in FIGS. 3a to 3c is the transmission 316 provided for movement of the displacement device 354. This transmission 316, by means of which the motor 314 moves the displacement device 350, comprises two telescopic spindles 358 that ensure that the extension of the robot gripper 300 in the direction of the robot arm 20 protrudes only slightly beyond the coupling device 312 also in the second relative end position of the holding device 354, as shown in FIG. 3a.

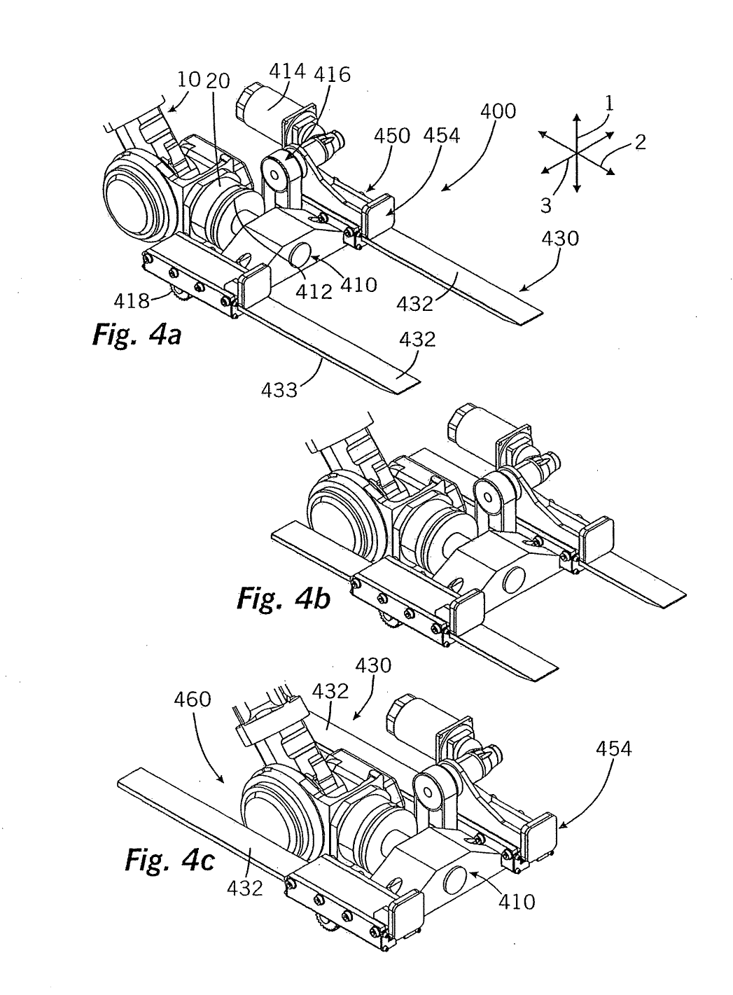

There is one substantial difference between the embodiment of the robot gripper 400 shown in FIGS. 4a to 4c and the preceding embodiments. As in the previous embodiments, the robot gripper 400 comprises a gripper base 410 that is connected to a robot arm 10 by means of a coupling device 412. However, the displacement device 450 together with the holding device 454 comprising two holding members 456 is immovably mounted with respect to this gripper base 410. In order to produce a relative movement between the displacement device 450 and the carrying device 430 comprising two prongs 432, provision is made for only the carrying device 430 to be capable of being moved relatively to the gripper base 410.

For this purpose, the underside of the prongs 432 is provided with teeth 433, which mesh with toothed wheels 418 of a transmission 416, to which a motor 414 is connected.

As shown by the first relative end position illustrated in FIG. 4c, it is nonetheless possible to achieve a state in which the displacement device 450 defines the distal end of the robot gripper 400 in the longitudinal direction 2 of the gripper.

In a manner similar to the embodiment shown in FIGS. 2a and 2c, provision is again made for the available space required for the relative movement of the displacement device 450 and the carrying device 430 to extend beyond the coupling device 412. As shown in the first relative end position shown in FIG. 4c, the two prongs 432 are displaced toward the rear on each side of the coupling device 412 far beyond the proximal end of the robot gripper 400 previously defined by the coupling device 412. As with the toothed racks 252 of the embodiment shown in FIGS. 2a to 2c, the prongs do not, or only scarcely, obstruct movement of the robot arm 10 by virtue of the free space 460 located between the prongs.

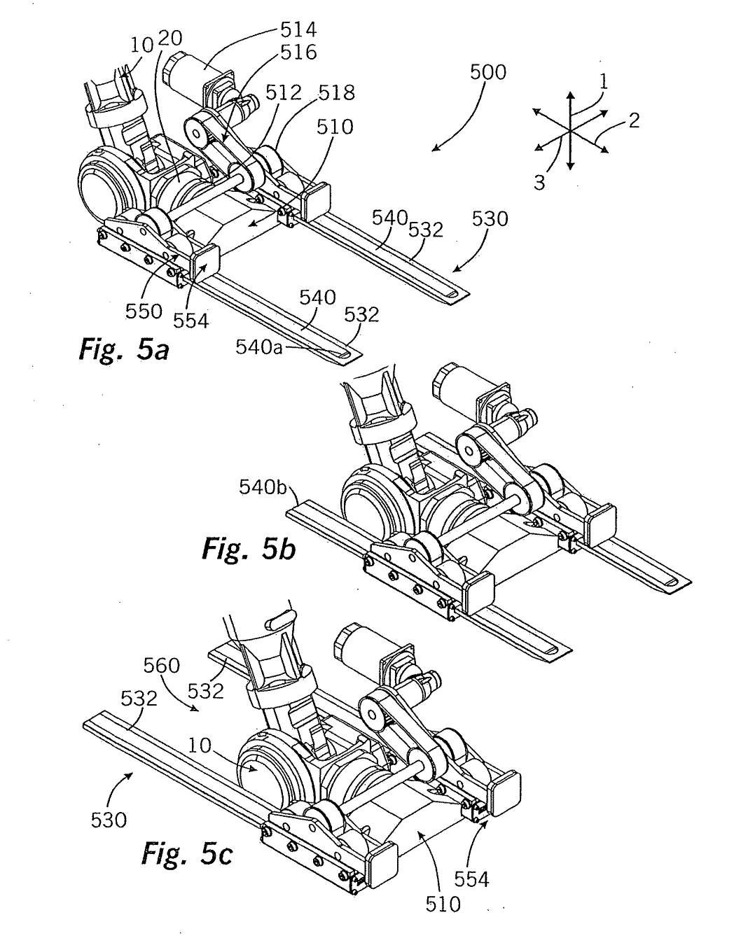

The basic relative movability of the main components of the robot gripper 500 shown in FIGS. 5a to 5c is comparable to the embodiment shown in FIGS. 4a to 4c. The displacement device 550 together with the holding device 554 is again disposed so as to be immovable with respect to a gripper base 510 and a coupling device 512 of the robot gripper 500. Here again, only the prongs 532 of the carrying device 530 are capable of being moved in the longitudinal direction 2 of the gripper relatively to the gripper base 510 and the displacement device 550. The extent of displaceability corresponds substantially to that achieved in the embodiment shown in FIGS. 4a and 4c so that, in the first relative end position shown in FIG. 5c, a considerable portion of the carrying device 530 protrudes to the rear beyond the gripper base 510 and the coupling device 512, and a free space 560 between the prongs 532 leaves room for the robot arm 10.

However, unlike the embodiment shown in FIGS. 4a to 4c, the drive is provided by means of a toothed belt 540 that is secured by means of its front end 540a and rear end 540b to the prongs 532 and that is guided around driving pinions 518 by means of an Ω wrap. The two driving pinions 518 are components of a transmission 516 that is driven by a motor 514. Both of the toothed belts 540 on the two carrying prongs 532 cooperate with the pinions 518 by means of teeth, which are not visible in the perspective views shown in FIGS. 5a to 5c, since they point downwardly from the underside of the belts.

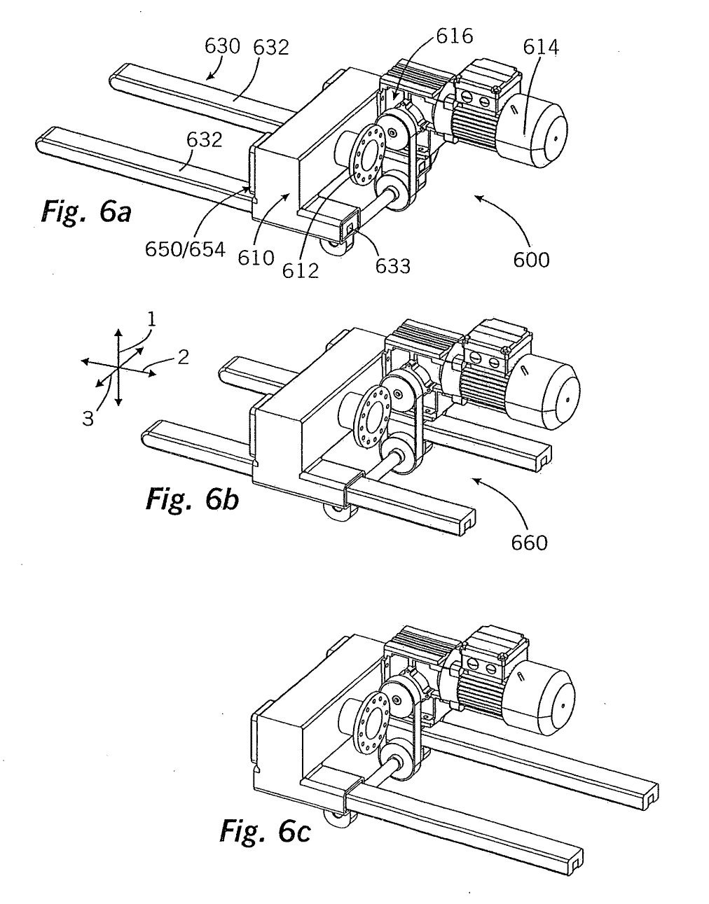

In contrast to the preceding embodiments, the embodiment shown in FIGS. 6a to 6c is shown in a view taken from the opposite side, so that the coupling device 612 provided on the gripper base 610 is clearly visible. The displacement device 650 together with the holding device 654 is likewise immovably mounted on the gripper base 610, in a similar, or the same, manner as illustrated in the embodiments shown in FIGS. 4a to 4c and 5a to 5c. Here again, two prongs 632 of a carrying device 630 that are coupled to a motor 614 by means of a transmission 616 are capable of being moved relatively to the gripper base 610.

It is clearly visible in the perspective views shown in FIGS. 6a to 6c that in the first relative end position shown in FIG. 6c, the prongs 632 have been moved until far beyond the coupling device 612, where they again do not obstruct any movement of the robot arm (not shown in this exemplary embodiment) by virtue of the free space 660 located between the prongs.

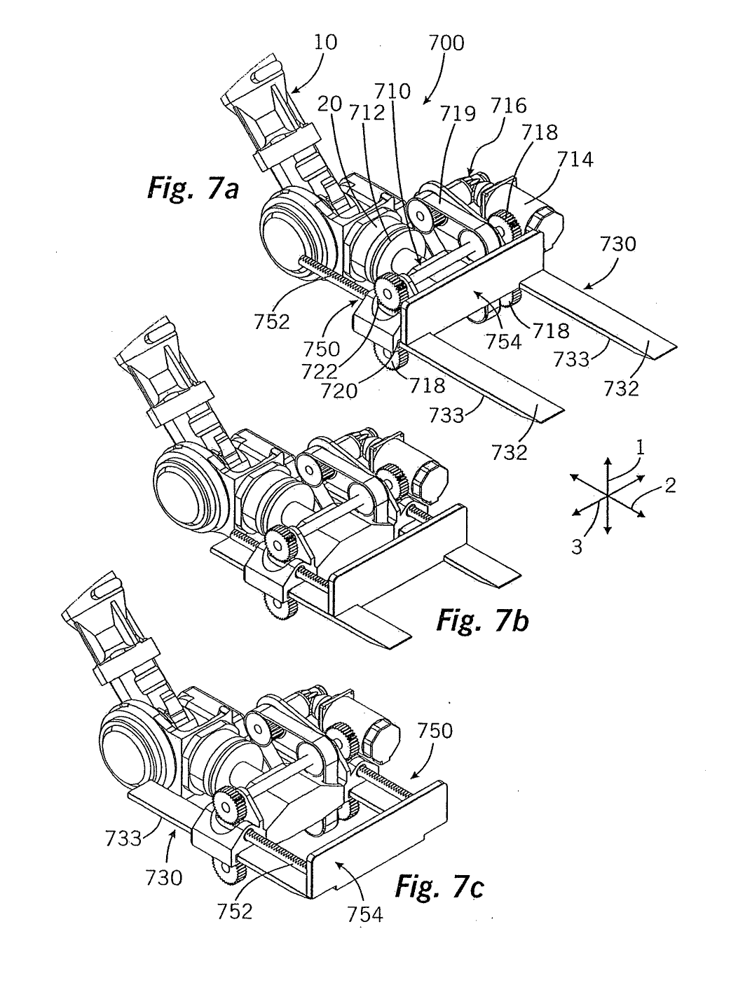

The embodiment of the robot gripper 700 shown in FIGS. 7a to 7c differs clearly from the preceding embodiments since both the displacement device 750 together with the holding device 754 and the carrying device 730 comprising the prongs 732 are capable of being moved relatively to the gripper base 710 and the coupling device 712 in the longitudinal direction 2 of the gripper. The prongs 732 are guided in guides 720 mounted on the gripper base 710 and they comprise teeth 733 on their underside, as in the embodiment shown in FIGS. 4a to 4c. In a manner similar to the embodiment shown in FIGS. 2a to 2c, the displacement device 750 comprises toothed racks 752, at the front end of which the holding device 754 is mounted. These toothed racks 752 are likewise guided in guides 722 that are immovably attached to the gripper base.

The motor 714 of the transmission 716 of the robot gripper 700, causes movement of both the carrying device 730 and the displacement device 750 relatively to the gripper base 710, and the said transmission comprises a total of four pinions 718 that are synchronized by means of a belt 719 so that the motor can cause the carrying device 730 and the displacement device 750 to move in a synchronized manner but in opposite directions.

The fact that both the displacement device 750 and the carrying device 730 are capable of being moved relatively to the gripper base 710 results in the advantage of a very compact form of the robot gripper 700 in the first end position thereof, shown in FIG. 7c. It is clearly visible that the prongs 732 scarcely protrude on the rear side beyond the coupling device 712 in this first end position. Also, in the second end position shown in FIG. 7a, the toothed racks 752 protrude only to a small extent beyond the coupling device 712. As a result, the scope of unrestricted movement of the robot gripper 700 relatively to the robot arm 10 is increased over that achievable in the preceding embodiments.

FIGS. 8 to 10 illustrate the mode of operation of a robot gripper of the invention exemplified by the robot gripper shown in FIGS. 1a to 1c. The entire robot gripper 100 including its robot arm 10 is shown in FIG. 8. The robot arm 10 in is turn pivotally mounted on fixed holding means 30.

For grasping an object 40 in transit, represented here by a suitcase to be loaded, the robot gripper 100 is initially positioned in the vicinity of a side wall 40a of the object 40 in transit, where it assumes a position in which it slopes downwardly toward its front end.

As shown in FIG. 8a, the displacement device 150 together with the holding device 154 is initially moved up to the front end of the carrying device 130 for loading the object 40 in transit. This is effected indirectly by means of the drive of the conveyor belt 140, as described above with reference to FIGS. 1a to 1c. The robot arm 10 causes the holding device 154 to be positioned on the object 40 in transit, as shown in detail in FIG. 9. The holding device 154 is positioned on the object 40 in transit such that the height A of the pivot axis 5 above the flat underlying surface 50, on which the object 40 in transit rests, is equal to the distance B, where B is the distance of the pivot axis 5 from the conveyor belt 140 in the upward vertical direction 1 of the gripper.

The holding contact established between the holding device 154 and the object 40 in transit, as shown in FIGS. 8a and 9, can thus remain unaltered even when the object 40 lies flat on the carrying surface of the carrying device 130 formed by the conveyor belt 140.

As described above, the holding device 154 is configured to produce the holding force required for manipulating the object 40 in transit by means of suction. This is effected in the state shown in FIGS. 8a and 9 so that the left-hand side of the object 40 in transit can then be lifted, as shown in FIG. 8b, by means of an overall displacement of the robot gripper 100, while the lower edge 40b on the opposite side of the object 40 in transit continues to rest on the ground. When the state shown in FIG. 8c is achieved, in which the underside 40c of the object 40 in transit aligns with the carrying device 130, the carrying device 130 is moved to underneath the object 40 in transit, as shown in FIG. 8d. This is achieved by a movement of the robot gripper 100 in its entirety by means of the robot arm 20, during which the displacement device 150 together with the holding device 154 moves at the same time in the opposite direction relatively to the carrying device 130 so that the object 40 in transit is scarcely moved during this phase. There is no undesirable rubbing contact between the top surface of the carrying device 130 formed by the conveyor belt 140 and the object 40 in transit, since the conveyor belt 140 is moved together with the displacement device 150 relatively to the remaining components of the robot gripper 100. As soon as the carrying device 130 has been moved to underneath the object 40 in transit beyond the center of gravity of the latter, the object 40 in transit can be lifted without any difficulty. Due to the holding force applied by the holding device 154, complete removal of the object 40 in transit from the flat underlying surface 50 can alternatively be achieved beforehand by lifting the distal end of the robot gripper 100.

The robot gripper of the invention thus allows for a gentle pickup of the object 40 in transit. There is no likelihood of damage occurring to the object 40 in transit.

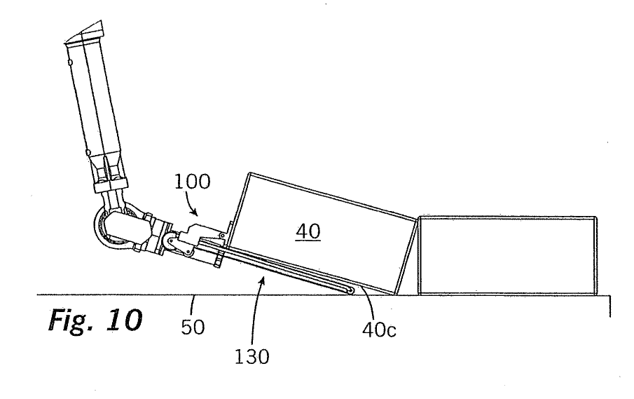

FIG. 10 shows a more advantageous variant depending on the embodiment of the robot gripper 100. The state shown in FIG. 10 corresponds to that shown in FIG. 8 as regards the loading phase. But in this variant, the carrying device 130 does not move to underneath the object 40 in transit in the direction of extension of the underside 40c of the same, but instead in a direction diverging slightly therefrom, so that intensive physical contact between the carrying device and the object 40 in transit does not occur until the intermediate state shown in FIG. 10 has been reached, after which the object 40 in transit is lifted by means of the carrying device 130, starting from the state shown in FIG. 10.

The unloading operation of the object 40 in transit in accordance with the designated use of the robot gripper takes place in reverse order to that described above with reference to the loading operation.

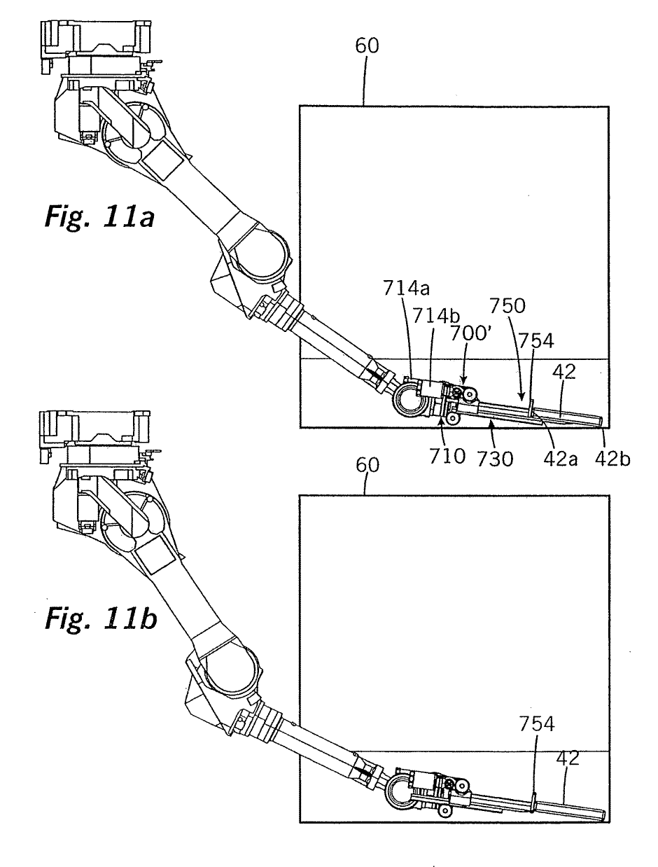

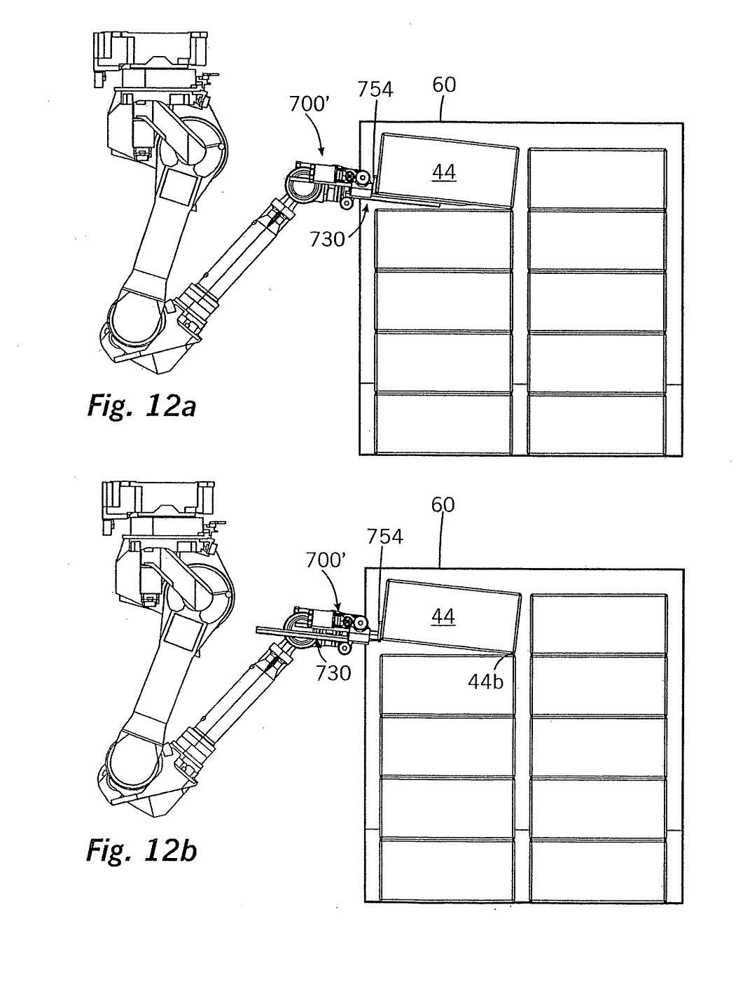

FIGS. 11a, 11b, 12a, and 12b illustrate loading operations carried out by a robot gripper 700′ of the invention. The latter differs from the robot gripper shown in FIGS. 7a to 7c mainly only in terms of two aspects. Firstly, the displacement device 750 and the carrying device 730 are each capable of being moved to a greater extent relatively to the gripper base 710 in the longitudinal direction 2 of the gripper. Secondly, instead of one common motor, there are provided two motors 714a, 714b that permit separate displacement of the displacement device 750, on the one hand, and of the carrying device 730, on the other, relatively to the gripper base 710.

These modifications of the robot gripper 700′ as compared with the robot gripper 700 allow greater flexibility of use, as a result of which the range of movement of the robot is increased. This is important, since it is advantageous for economical reasons to use comparatively small robots. The increased range of movement is necessary or at least advantageous in order to still make it possible for small robots to completely load a container 60 as commonly used in aircraft.

FIGS. 11a and 11b illustrate an unloading operation of a piece of baggage 42 in the bottom right-hand corner of the container 60 in the view shown in FIGS. 11a and 11b. Before being unloaded, the piece of baggage 42 lies on the carrying device 730 that is moved as far as possible in the direction of the distal end of the robot gripper 700′. The displacement device 750 is also moved over a large distance in the direction of the distal end of the robot gripper 700′, so that the center of gravity of the piece of baggage 42 is still located above the carrying device 730. In this state, the bottom right-hand edge 42b of the piece of baggage 42 is deposited on the base of the container 60. This is illustrated in FIG. 11a.

The carrying device 730 is then moved toward the proximal end of the robot gripper 700 until it is no longer disposed underneath the piece of baggage 42, as illustrated in FIG. 11b. Starting from this state shown in FIG. 11b, the piece of baggage, held by means of the holding device 754, can be deposited gently.

FIGS. 12a and 12b show the manner in which a piece of baggage 44 is deposited in the opposite top left-hand corner of the container 60. This depositing operation takes place in substantially the same way as the depositing operation shown in FIGS. 11a and 11b. The essential difference between the two operations is that the displacement device 750 together with the holding device 754 is in its end position, in which it is located closest to the gripper base 710 at the start of the unloading operation, so that the piece of baggage 44 is also disposed very close to the gripper base 710 prior to being unloaded. As soon as the bottom right-hand edge 44b of the piece of baggage is dumped, as shown in FIG. 12a, the carrying device 730 is retracted. At the same time, the robot gripper 700 is also moved in its entirety backwards to a certain extent to make it possible to pull out the carrying device completely from underneath the piece of baggage 44. Furthermore, the displacement device 750 together with the holding device 754 is moved forward at the same time to a slight extent in order to keep the piece of baggage 44 in position. Thus the state shown in FIG. 12b is achieved in which only the holding device 754 of the robot gripper 700′ is still in contact with the piece of baggage 44. Starting from this position, the piece of baggage can be deposited gently by the holding device 754, which is moved together with the robot gripper 700.

Thus the variant of a robot gripper 700′ of the invention shown in FIGS. 11a to 12b allows the range of movement of the robot to be increased considerably in practice due to the capability of the displacement device 750 and the carrying device 730 to be moved separately.

1. A robot gripper (100) for grasping, transporting, and depositing goods in transit (40, 42, 44), more particularly pieces of baggage such as suitcases and traveling bags, comprising
a gripper base (110) having a coupling device (112) for attachment to a robot arm (10),
a carrying device (130) extending in the longitudinal direction (2) of said gripper and having a carrying surface (140) serving to carry the object in transit and extending substantially in the longitudinal direction (2) of said gripper and in a transverse direction (3) of said gripper
a displacement device (150) disposed above said carrying device (130) in an upward vertical direction (1) of said gripper and serving to apply force to said object (40, 42, 44) in transit in the longitudinal direction (2) of said gripper
wherein
said carrying device (130) and said displacement device (150) are capable of being moved relatively to each other in the longitudinal direction (2) of said gripper,
characterized in that
on said displacement device (150) there is disposed a holding device (154), by means of which a holding force can be generated for the purpose of preventing an object (40, 42, 44) in transit resting against said holding device (154) from losing contact with said holding device (154).

2. The robot gripper as defined in claim 1,
characterized in that
said holding device (154) is in the form of a switchable holding device (154), wherein said holding device preferably comprises
at least one suction means (156a) for holding said object (40, 42, 44) in transit by means of negative pressure,
at least one electromagnet for holding said object in transit by means of magnetic force, or
at least one passively effective holding surface which can be moved in a controlled manner as regards the relative position thereof to the carrying device in the upward vertical direction of said gripper and/or in the transverse direction of said gripper.

3. The robot gripper as defined in claim 1 or claim 2,
characterized in that
said holding device (154) is mounted for rotation about a pivot axis (150) of said holding device relatively to said gripper base (110) or relatively to a main portion (152) of said displacement device (5), which pivot axis (5) of the holding device is preferably at an unalterable distance from said contact surface (140) of said carrying device (130).

4. The robot gripper as defined in claim 1,
characterized in that
said carrying device (130) and said displacement device (150) are capable of being moved relatively to each other such that said holding device (154) is capable of being set up in a first relative end position in the longitudinal direction (2) of said gripper ahead of a distal end (110) of said carrying device (130) remote from said gripper base (136).

5. The robot gripper as defined in claim 4,
characterized in that
said displacement device (150) and said carrying device (130) are capable of being moved relatively to each other such that in the first relative end position the following situation can be obtained:
a) said robot gripper (100) slopes downwardly at its distal end in relation to a flat underlying surface (50), the longitudinal direction (2) of said gripper enclosing an angle (α) of less than 45° and preferably an angle (α) of less than 30° with said flat underlying surface (50),
b) said carrying device (130) rests on said flat underlying surface (50), and
c) a cuboidal object in transit (40) lies flat on said flat underlying surface (50), said holding device (154) rests against said object (40) in transit at a height (A) above said underlying surface (50) that is the same as the height (B) at which said holding device (130) would rest against said object (40) in transit if the latter were lying in a flat position on said carrying surface (140) of said carrying device (130).

6. The robot gripper as defined in claim 1,
characterized in that
said carrying device (130) is immovably mounted on said gripper base (110) or is mounted for rotation relatively to said gripper base about a carrying device axis oriented in the transverse direction of said gripper and
said displacement device (150) is capable of being moved relatively to said carrying device (130):

7. The robot gripper as defined in claim 1,
characterized in that
in a second relative end position the portion of the carrying device (130) disposed ahead of said holding device (150) has a length in the longitudinal direction of the gripper of at least 15 cm, preferably of at least 35 cm and more preferably of at least 45 cm:

8. A robot gripper (100) for grasping, transporting, and depositing goods in transit (40, 42, 44), more particularly pieces of baggage such as suitcases and traveling bags, comprising
a gripper base (110) having a coupling device (112) for attachment to a robot arm (10),
a carrying device (130) extending in the longitudinal direction (2) of said gripper and having a carrying surface (140) serving to carry the object in transit and extending substantially in the longitudinal direction (2) of said gripper and in a transverse direction (3) of said gripper
a displacement device (150) disposed above said carrying device (130) in an upward vertical direction (1) of said gripper and serving to apply force to said object (40, 42, 44) in transit in the longitudinal direction (2) of said gripper
wherein
said carrying device (130) and said displacement device (150) are capable of being moved relatively to each other in the longitudinal direction (2) of said gripper,
characterized in that
said carrying device (430) is capable of being moved relatively to said gripper base (410) in the longitudinal direction (2) of said gripper
said carrying device (430) has at its proximal end facing said gripper base (410) two end portions (432) spaced apart in the transverse direction (3) of said gripper to leave a free space (460) therebetween, and
said end portions (432) of said carrying device (430) are disposed, in the end position of the carrying device (430) oriented toward said gripper base, such that
each is disposed to the rear of said coupling device (412), as regarded in the longitudinal direction (2) of said gripper, and
they are opposite each other in the transverse direction (3) of said gripper on each side of said coupling device (412).

9. A robot gripper (100) for grasping, transporting, and depositing goods in transit (40, 42, 44), more particularly pieces of baggage such as suitcases and traveling bags, comprising
a gripper base (110) having a coupling device (112) for attachment to a robot arm (10),
a carrying device (130) extending in the longitudinal direction (2) of said gripper and having a carrying surface (140) serving to carry the object in transit and extending substantially in the longitudinal direction (2) of said gripper and in a transverse direction (3) of said gripper
a displacement device (150) disposed above said carrying device (130) in an upward vertical direction (1) of said gripper and serving to apply force to said object (40, 42, 44) in transit in the longitudinal direction (2) of said gripper
wherein
said carrying device (130) and said displacement device (150) are capable of being moved relatively to each other in the longitudinal direction (2) of said gripper,
characterized in that
said displacement device (250) is capable of being moved relatively to said gripper base (210) and/or relatively to said carrying device (230) in the longitudinal direction (2) of said gripper
said displacement device (250) has, at its proximal end, two subtransmissions (252) spaced apart in the transverse direction (3) of said gripper leaving a free space (260) therebetween and
said subtransmissions (252) in the end position of said displacement device (250) oriented toward said gripper base (210) are disposed such that
each is disposed to the rear of said coupling device (212), as regarded in the longitudinal direction (2) of said gripper, and
they are opposite each other in the transverse direction (3) of said gripper on each side of said coupling device (212).

10. The robot gripper (500) as defined in any one of the previous claims,
characterized in that
said carrying device (530) is capable of being moved relatively to said gripper base (510) in the longitudinal direction (2) of said gripper, wherein a driving belt (540) is mounted at opposite ends of said carrying device (530) and said driving belt is wrapped in the form of an Ω around two guides that are immovable in relation to said gripper base and around a driving pinion (518) which is mounted for rotation about a driving axis that is immovable in relation to said gripper base (510).

11. The robot gripper as defined in any one of the previous claims,
characterized in that said carrying device (130) comprises a main portion (134) and also a carrying element (140) that is guided on said main portion (134) and is capable of being moved relatively to said main portion (134) preferably in the form of a conveyor belt (140) which forms the carrying surface (140) of said carrying device (130) and wherein, preferably,
said carrying element is at least in part rigidly attached to said gripper base and said main portion of said carrying device is capable of being moved relatively to said gripper base, or
said carrying element (140) is in its entirety capable of being moved relatively to said gripper base (110) and preferably said displacement device (150) is rigidly connected to a portion of said carrying element (140).

12. The robot gripper (300) as defined in any one of the previous claims,
characterized in that
for the purpose of moving said displacement device (350) and/or said carrying device relatively to said gripper base (310) a telescopic mechanism is provided having an intermediate member (358), wherein said intermediate member (358) is capable of being moved relatively to said gripper base (310) in the longitudinal direction (2) of said gripper and wherein, actively coupled thereto, said displacement device (350) is moved relatively to said intermediate member (358) in the longitudinal direction (2) of said gripper.

13. A manipulating robot particularly adapted for grasping, transporting, and depositing goods in transit (40, 42, 44), more particularly pieces of baggage such as suitcases and traveling bags, comprising
a robot base (30), which is immovable or is displaceable via a system of rails
a robot arm (10) which is capable of being moved relatively to a robot base (30) and at the end of which a coupling device (20) is provided for the attachment of a robot gripper,
characterized in that
on said coupling device (20) of said robot arm (10) there is mounted a robot gripper (100, 200, 300, 400, 500, 600, 700, 700′) as defined in any one of the claim 1, 8 or 9.

14. A method of grasping an object in transit (40, 42, 44) from a substantially flat underlying surface (50) by means of a robot gripper as defined in any one of claim 1, 8 or 9,
characterized in that
starting from an initial state in which said carrying device (130) and said holding device (154) are in a relative position in which said carrying device (130) is disposed to the rear of said holding device (154)
said holding device (154) is moved so as to approach a side face (40a) of said object in transit (40) while said carrying device (130) is oriented to slope downwardly toward its distal end relatively to said underlying surface (50),
said holding device (154) is brought into holding contact with said side face (40a),
said holding device (154) and more particularly the entire robot gripper (100) including said holding device (154) is raised such that said side face (40a) of said object in transit in contact with said holding device (154) is raised with simultaneous tilting of said object (40) in transit,
said carrying device (130) is moved forward relatively to said holding device (154) and thus to underneath said object (40) in transit, and
said object (40) in transit is lifted by means of said carrying device (130) and thus removed from said flat underlying surface (50).

15. A method of depositing an object in transit from a robot gripper as defined in any one of claims 1, 8, 9,
characterized in that
starting from an initial state in which said object in transit (42, 44) lies on said carrying device (730) and is in holding contact with said holding device (754),
said carrying device (730) is brought into a downwardly sloping position relative to an approximately flat underlying surface,
one edge (42b, 44b) of said object (42, 44) in transit is placed on said underlying surface
said carrying device (730) is distended to underneath said object in transit (42, 44) whilst continued holding contact is maintained between said object (42, 44) in transit and said holding device (754), and
said object in transit (42 44) is lowered by means of said holding device (754) until it rests completely on said underlying surface:
